(19) United States
(12) Patent Application Publication
(10) Pub. No.: US 2009/0064034 A1
(43) Pub. Date: Mar. 5, 2009

(54) IMAGE DISPLAYING DEVICE AND METHOD FOR DISPLAYING IMAGES AND RELATED INFORMATION

(75) Inventors: XIAO-GUANG LI, Shenzhen City (CN); KUAN-HONG HSIEH, Tu-Cheng (TW); LI WANG, Shenzhen City (CN); ZAI-AN PAN, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/202,419

(22) Filed: Sep. 1, 2008

(30) Foreign Application Priority Data
Aug. 31, 2007 (CN) 200710076756.4

(51) Int. Cl. G06F 3/048

(52) U.S. Cl. 715/803

(57) ABSTRACT

An image displaying device for displaying images and related information is provided. The image displaying device includes a display unit, a storage and a central controller. The storage stores at least an image file and at least a related information file associated with the image files. The central controller includes a display controller which is configured for dividing the display unit into a first region and a second region and displaying an image defined by the image file in the first region and related information recorded by the related information file in the second region. A related method is also provided.

### BACKGROUND

1. Technical Field

The present invention relates to image displaying devices and methods thereof, and particularly to an image displaying device and method for displaying images and related information thereof.

2. General Background

Generally, when either using a traditional photo frame to display a paper photo, or using a digital photo frame to display a digital photo, people would like to be able to see photo-related information, such as a photographing date, a photographing place, people in the photo, and feelings at the time of taking the photo. The information will help people to recall precious moments or details of how the photo was taken.

Photo-related information is easy to forget especially for old photographs. In traditional photography, people may write notes at the time and later copy those notes to the back of a photograph. However, note writing is not applicable for digital photography. Camera generated data marks only offer time information and the data marks may affect the beautifulness of the photograph.

What is needed, therefore, is an image displaying device and method which can solve the problem mentioned above.

### SUMMARY

An image displaying device for displaying images and related information is provided. The image displaying device includes a display unit; a storage for storing at least an image file and at least a related information file, the at least one related information file being associated with one of the at least one image file; and a display controller for dividing the display unit into a first region and a second region and displaying an image defined by the image file in the first region and related information from the related information file in the second region.

Other advantages and novel features will be drawn from the following detailed description with reference to the attached drawings.

### BRIEF DESCRIPTION OF THE DRAWINGS

The components of the drawings are not necessarily drawn to measuring scale, the emphasis instead being placed upon clearly illustrating the principles of the image displaying device and method for displaying images and related information. Moreover, in the drawings, like reference numerals designate corresponding parts throughout the several views.

FIG. 1 is a block diagram of hardware of an image displaying device in accordance with a first embodiment of the present invention.

FIGS. 2 and 3 show interfaces enabling users to associate image files with related information files, as implemented by the displaying device of FIG. 1.

FIG. 4 shows a table of relationship information between the image files and the related information files.

FIG. 5 is a block diagram of hardware of an image displaying device in accordance with a second embodiment of the present invention.

FIG. 6 is a flowchart of a method for displaying images and related information.

### DETAILED DESCRIPTION OF THE EMBODIMENTS

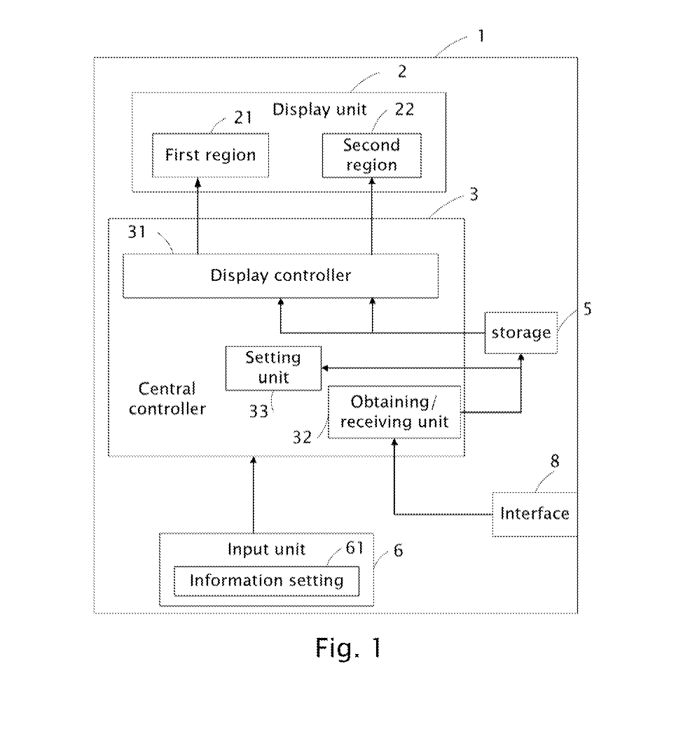

FIG. 1 is a block diagram of hardware of an image displaying device in accordance with a first embodiment of the present invention. The image displaying device 1 mainly includes a display unit 2, a central controller 3, a storage 5, an input unit 6, and an interface 8. The input unit 6 is provided with a plurality of input keys, which can be mechanical keys, touch type keys, or any other type keys enabling users to operate the image displaying device 1. The storage 5 is provided for storing a plurality of image files and related information files. The image files define images and the related information files store related information of the images. The image files and the related information files are generally obtained or received from other devices by an obtaining/receiving unit 32 of the central controller 3 via the interface 8. Typically, the obtaining/receiving unit 32 obtains image files and/or related information files from different types of memory cards, such as MMC, SD, and so on, when the memory cards are connected to the image displaying device. The obtaining/receiving unit 32 can also receive image files and/or related information files from different types of electronic devices such as a computer when the image displaying device 1 is connected to the device. The central controller 3 reads the image files and the related information files from the storages and displays the images and the related information on the display unit 2. The central controller 3 includes a display controller 31. The display controller 31 divides the display unit 2 into a first region 21 and a second region 22 and controls the images to be displayed in the first region 21 and the related information in the second region 22.

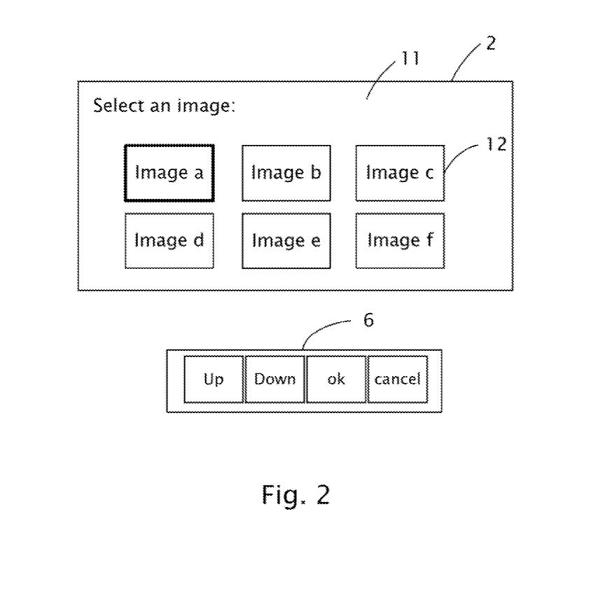

The central controller 3 further includes a setting unit 33. The setting unit 33 is provided for information setting of the image files, i.e., associating the related information files with the image files based on the users' operations. The setting unit 33 is activated by the users when the users press an information setting key 61 of the input unit 6 to send an information setting signal to the setting unit 33. The setting unit 33 brings up an image selection interface 11 shown in FIG. 2 on the display unit 2 via the display controller 31.

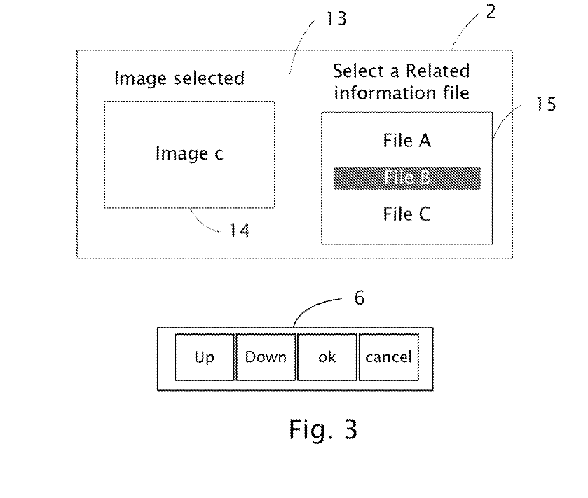

Referring to FIG. 2, the image selection interface 11 shows thumbnails 12 of the images. The users can operate Up/Down keys of the input unit 6 to move a cursor on the image selection interface 11, thus marking a thumbnail 12 of a desired image. The users can further click an Ok key of the input unit 6 to select the desired image or click a cancel key of the input unit 6 to end the information setting. If the users select the desired image, a related information selection interface 13 shown in FIG. 3 is displayed on the display unit 2 by the setting unit 33, replacing the image selection interface 11.

Referring to FIG. 3, the selected image 14 occupies a left region of the display unit 2 and a related information file list occupies a right region of the display unit 2. The users can operate the Up/Down keys and the Ok key to select a related information file or operate the cancel key to return to the image selection interface 11. If the users select a related information file, the related information file is associated with the selected image by the setting unit 33. In one example, the setting unit 33 marks the related information file by renaming the related information file by the same name as that of the selected image file. By doing so, the related information file has a same name but a different suffix as the selected image. The central controller 3 searches the storage 5 for the related information file according to the name of the image file when the image and the related information are both required to be displayed.

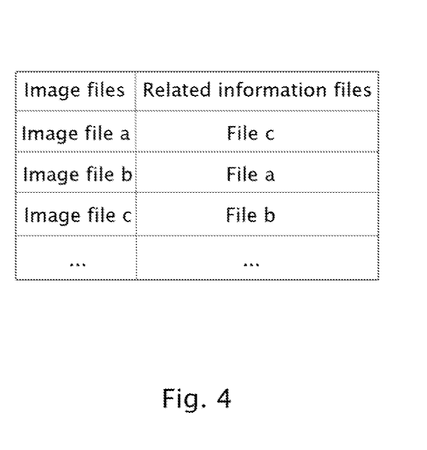

In another example, the setting unit 33 generates a table of relationship information between the image files and the related information files. An example of such a table is shown in FIG. 4. The central controller 3 searches the storage 5 for the related information file of the image file according to the relationship information recorded in the table when the image and the related information are both required to be displayed.

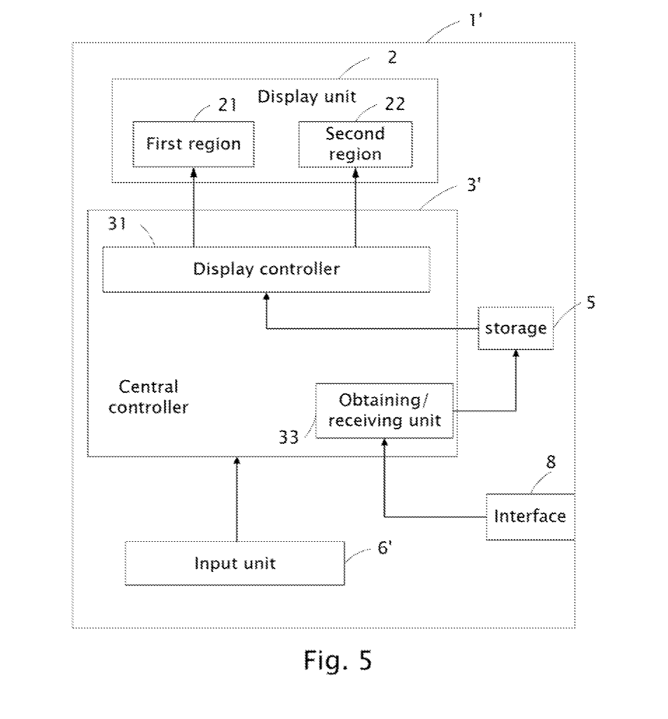

Referring to FIG. 5, a block diagram of hardware of an image displaying device 1′ in accordance with a second embodiment of the present invention is provided. Compared with the image displaying device 1, a central controller 3′ of the image displaying device 1′ omits the setting unit 33. The central controller 3′ obtains or receives image files and related information files pre-associated with the image files from memory cards or other electronic devices. Accordingly, an input unit 6′ of the image displaying device 1′ omits the information setting key 61 which is provided for activating the information setting of the image files in the first embodiment. Other components of the image displaying device 1′ that are essentially the same as those in the image displaying device 1 are indicated by the same numerals and explanations thereof are omitted.

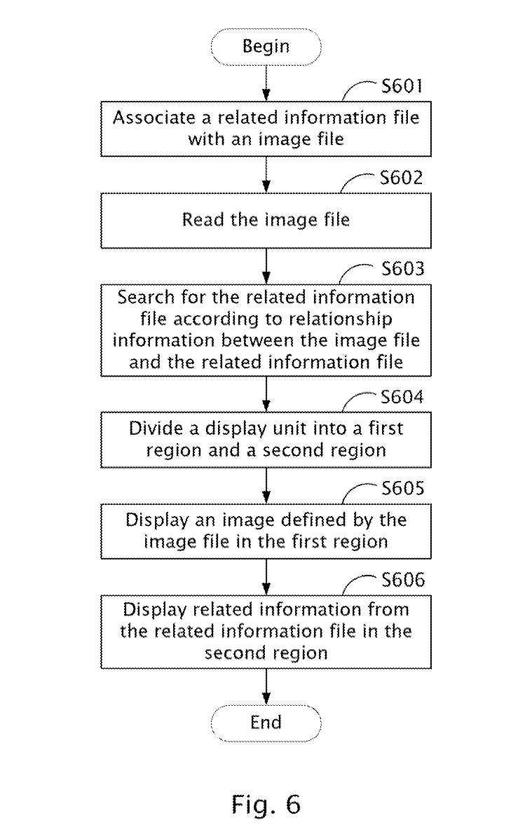

Referring to FIG. 6, a flowchart of a method for displaying images and related information is shown. First, in step S601, the setting unit 33 associates a related information file with an image file based on operations of the users. In step S602, the central controller 3 or 3′ reads the image file from the storage 5. In step S603, the central controller 3 or 3′ searches in the storage 5 for the related information file based on relationship information between the image file and the related information file. Generally, the related information file may have a same name as that of the image file and the central controller 3 or 3′ searches the related information file according the name of the image file, or the storage 5 may store a table which records the relationship information between the image file and the related information file and the central controller 3 or 3′ searches the related information file based on the relationship information recorded in the table. Either way, the central controller 3 or 3′ will obtain the related information file from the storage 5 so long as the related information file exists in the storage 5. In step S604, the display controller 31 divides the display unit 2 into a first region 21 and a second region 22. In step S605, the display controller 31 displays the image defined by the image file in the first region 21. In step S606, the display controller 32 displays the related information recorded by the related information file in the second region 22. The procedure is accordingly finished.

Although the present invention has been specifically described on the basis of exemplary embodiments thereof, the invention is not to be construed as being limited thereto. Various changes or modifications may be made to the embodiment without departing from the scope and spirit of the invention.

What is claimed is:

1. An image displaying device for displaying images and related information, comprising:
a display unit;
a storage for storing at least one image file and at least one related information file, each of the at least one related information file being associated with one of the at least one image file respectively; and
a central controller, comprising:
a display controller configured for dividing the display unit into a first region and a second region and displaying an image defined by the image file in the first region and related information recorded in the related information file in the second region.

2. The image displaying device as claimed in claim 1, further comprising an interface unit for connecting the image displaying device to another device.

3. The image displaying device as claimed in claim 2, further comprising an obtaining/receiving unit configured for obtaining or receiving the at least one image file and the at least one related information file from the another device via the interface.

4. The image displaying device as claimed in claim 3, wherein the obtaining/receiving unit is configured for obtaining the at least one image file and the at least one related information file from a memory card.

5. The image displaying device as claimed in claim 3, wherein the obtaining/receiving unit is configured for receiving the at least one image file and the at least one related information file from an electronic device.

6. The image displaying device as claimed in claim 1, wherein the central controller further comprises a setting unit configured for associating each of the at least one related information file with one of the at least one image file.

7. The image displaying device as claimed in claim 6, wherein the setting unit is configured for associating each related information file with one of the at least one image file by renaming the related information file with the same name as that of the image file.

8. The image displaying device as claimed in claim 6, wherein the setting unit is configured for generating a table recording relationship information between the image file and the related information file for associating each of the at least one related information file with one of the at least one image file.

9. A method for displaying images and related information, comprising:
reading an image file from a storage;
searching the storage for a related information file according to relationship information between the image file and the related information file;
dividing a display unit into a first region and a second region; and
displaying an image defined by the image file in the first region and a related information recorded in the related information file in the second region.

10. The method as claimed in claim 9, further comprising the step of receiving the image file and the related information file from an electronic device and storing the image file and the related information file in the storage.

11. The method as claimed in claim 9, further comprising the step of obtaining the image file and the related information file from a memory card and storing the image file and the related information file in the storage.

12. The method as claimed in claim 9, further comprising the step of associating the related information file with the image file so that to generate the relationship information.

13. The method as claimed in claim 12, wherein the associating step comprising renaming the related information file with the same name as that of the image file.

14. The method as claimed in claim 12, wherein the associating step comprising generating a table to record the relationship information.
